(19) United States
(12) Patent Application Publication
(10) Pub. No.: US 2024/0308656 A1
(43) Pub. Date: Sep. 19, 2024

(54) NAVIGABLE AERONAUTICAL AND NAUTICAL CRAFT

(71) Applicant: Orbital Composites, Inc., San Jose, CA (US)

(72) Inventors: Cole NIELSEN-COLE, San Jose, CA (US); Darrell E. Stevens, Jacksboro, TN (US); James Frei, Dixon, CA (US)

(21) Appl. No.: 18/121,564

(22) Filed: Mar. 14, 2023

(51) Int. Cl. B64C 35/00; B64C 1/06; B64C 21/02; B64C 25/10; B64C 29/00; B64C 39/08; B64D 17/62

(52) U.S. Cl. CPC B64C 35/008; B64C 1/069; B64C 21/025; B64C 25/10; B64C 29/005; B64C 35/005; B64C 39/08; B64D 17/62; B64C 1/22

(57) ABSTRACT

A navigable craft that includes a fuselage with a tiltable section positioned behind a non-tiltable section opposite to a nose. A set of wing assemblies connected to the non-tiltable section of the fuselage. Each wing assembly includes an airfoil connected to the non-tiltable section of the fuselage at a first cross-sectional end of the airfoil and a non-tiltable propulsion generator connected to a second cross-sectional end of the airfoil opposite to the first cross-sectional end of the airfoil. The propulsion generator extends parallel and adjacent to the non-tiltable section of the fuselage, and one or more stabilizers connected to at least one of the non-tiltable propulsion generator, the airfoil, and the fuselage. The landing assembly is connected to the propulsion generator or the airfoil. The landing assembly is aligned aerodynamically with the second cross-sectional end and extends in a direction adjacent to the tiltable section of the fuselage.

### FIELD

The present disclosure generally relates to a nautical/aeronautical craft, more specifically to a navigable craft adapted for landing on water and on substantially uneven terrain.

### BACKGROUND

Navigable craft are optimized for either land, water, air, or space. Some craft have been designed to equally navigate both land and water (e.g., amphibious craft, DUKW, etc.) or to equally navigate both land and air (e.g., air car, flying car, etc.). However, few craft have been designed to equally navigate in both air and water and even fewer of such craft are capable of landing on substantially uneven terrain. As such, craft capable of navigating in both air and water and/or landing on uneven terrain are desirable.

### BRIEF SUMMARY

The following presents a simplified summary of one or more embodiments in order to provide a basic understanding. This summary is not an extensive overview of all contemplated examples and is intended to neither identify key or critical elements of all embodiments nor delineate the scope of any or all embodiments. Its purpose is to present some concepts of one or more embodiments in a simplified form as a prelude to the more detailed description that is presented below.

In accordance with some embodiments, a navigable craft, includes a fuselage with a tiltable section positioned behind a non-tiltable section; and a set of wings connected to the non-tiltable section of the fuselage. Each wing of the set of wings includes: an airfoil connected to the non-tiltable section of the fuselage at a first cross-sectional end of the airfoil and a non-tiltable propulsion generator connected to a second cross-sectional end of the airfoil opposite to the first cross-sectional end of the airfoil. The propulsion generator for each wing of the set of wings extends parallel and adjacent to the non-tiltable section of the fuselage. The navigable craft further includes one or more stabilizers connected to at least one of the non-tiltable propulsion generators, the airfoil, and the fuselage. The navigable craft further includes a landing assembly connected to the propulsion generator or the airfoil. The landing assembly is aligned aerodynamically with the second cross-sectional end of the airfoil and extends in a direction adjacent to the tiltable section of the fuselage.

### BRIEF DESCRIPTION OF THE FIGURES

For a better understanding of the various described aspects, reference should be made to the description below, in conjunction with the following figures in which like-referenced numerals refer to corresponding parts throughout the figures.

FIG. 1 illustrates a navigable craft positioned on a sloped terrain.

FIG. 2 illustrates the navigable craft in vertical flight mode after take-off from the sloped terrain or prior to landing on the sloped terrain.

FIG. 3 illustrates the navigable craft when transitioning between vertical flight mode and horizontal flight mode.

FIG. 4 illustrates the navigable craft when moving through the fluid in horizontal flight mode.

FIG. 5 illustrates the rotational capabilities of the fuselage stabilizer and the rotatable airfoil for the navigable craft.

FIG. 6 illustrates a deployed parachute affixed to the navigable craft that is utilized for emergencies.

FIG. 7 illustrates the navigable craft oriented in vertical flight mode before take-off or after landing on water.

FIG. 8 illustrates the navigable craft oriented in horizontal flight mode on water.

FIG. 9 illustrates the navigable craft oriented in horizontal flight mode below the water.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details.

In general, a navigable craft can be manned (e.g., airplane, helicopters, automobiles, boats, etc.) or unmanned (e.g., manual or computer-controlled drones). Navigable craft are configured to maneuver through two different fluids, such as air or water. A fluid is any substance that continually deforms (e.g., flows) under an applied shear stress, or external force. Fluids include phases of matter, liquids, gases and plasmas. Fluids are substances with zero shear modulus, or, in simpler terms, substances which cannot resist any shear force applied to them.

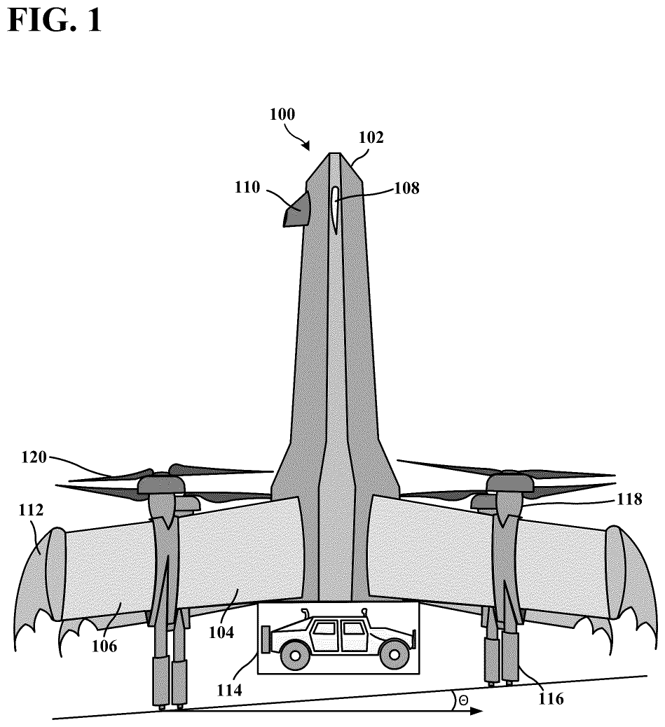

FIG. 1 illustrates a navigable craft 100 positioned on a sloped terrain. The navigable craft 100 includes a fuselage 102 that has a tiltable section (e.g., the compartment 114) that is positioned behind a non-tiltable section (e.g., the portion of the fuselage 102 that extends from the wings to the nose) relative to the front of the navigable craft. In some embodiments, the tiltable section includes an adjustable mechanism connected to the non-tiltable section. In some embodiments, the tiltable section of the fuselage is configured to tilt based on direction of gravity field in order to align a floor of the tiltable fuselage section to the ground. For example, the adjustable mechanism adjusts the position of the tiltable section so that an attached floor of compartment 114 remains oriented to the ground while the craft is moving.

In some embodiments, the compartment 114 is connected to the tiltable section of the fuselage 102 and is detachable from the adjustable mechanism. In some embodiments, the adjustable mechanism includes brackets to secure the compartment 114 to the tiltable section of the fuselage 102. In some embodiments, the compartment 114 corresponds to a cockpit. In some embodiments, the compartment 114 corresponds to a cargo container. In some embodiments, the compartment 114 corresponds to a medical transport.

The navigable craft 100 further includes a set of wings connected to the non-tiltable section of the fuselage 102. As depicted in FIG. 1, each wing of the set of wings includes an airfoil 104 connected to the non-tiltable section of the fuselage 102 at a first cross-sectional end of the airfoil 104. In some embodiments, the airfoil 104 are deformable and are configured with ailerons and/or flaps that change a cross-section from a cross-sectional end of an airfoil 104 to an opposite cross-sectional end of the airfoil 104.

Each wing of the set of wings further includes a propulsion generator 118 connected to a second cross-sectional end of the airfoil 104 opposite to the first cross-sectional end of the airfoil 104. The propulsion generator 118 is non-tiltable. In some embodiments, as depicted in FIG. 1, each propulsion generator 118 is above the wing and extends parallel and adjacent to the non-tiltable section of the fuselage 102. In some embodiments, one or more propulsion generators 118 are below the wing and extend parallel to the non-tiltable section of the fuselage 102. In some embodiments, one or more of the propulsion generators 118 corresponds to an electric motor or a fuel driven engine with a propeller (e.g., rotor). In some embodiments, one or more of the propulsion generators 118 include a jet engine and a turbine. In some embodiments, one or more of the propulsion generators 118 include a jet engine that can redirect the engine inlet or the exhaust plume. In some embodiments, one or more of the propulsion generators 118 include a jet engine and a propeller (e.g., turbo prop/propeller). In some embodiments, one or more of the propulsion generators 118 include thrustors (e.g., gas thrustor, compressed air, rocket, plasma, etc.). In some embodiments, the propulsion generator is hermetically scaled.

In some embodiments, one or more of the propulsion generators 118 includes differential rotation per minute control. The differential rotation per minute control is configured to “trim” in order to offset the rotation velocity of a propeller (e.g., rotor, turbine) to provide aerodynamic reaction control forces for greater maneuverability. This helps maneuverability against the moment of inertia (which increases as a function of r²) when the propeller (e.g., rotor, turbine) are used in the propulsion generators 118.

In some embodiments, one or more of the propulsion generators 118 are coaxially aligned. In some embodiments, the propeller (e.g., rotor, turbine) of coaxially aligned propulsion generators 118 rotate in opposite directions. In some embodiments, differential rotation per minute control is configured to counter rotating the propeller (e.g., rotor, turbine) of coaxially aligned propulsion generators 118 in the event that one of the propellers (e.g., rotor, turbine) stops functioning (e.g., stops rotating). For example, in such an event the differential rotation per minute control can distribute additional power to the remaining functioning propellers (e.g., rotor, turbine) in order to compensate for the propeller (e.g., rotor, turbine) that stopped functioning (e.g., stops rotating).

In some embodiments, one or more of the propulsion generators 118 includes differential collective propeller (e.g., rotor) pitch control. The differential collective propeller (e.g., rotor) pitch control is configured to equal, differential, and/or static dynamic rotation per minute control between different propulsion generators 118. Differential collective propeller (e.g., rotor) blade pitch often provides thrust vectoring system that provides a powerful and responsive reaction control of the navigable craft 100 because less energy is expended in braking or accelerating the propeller (e.g., rotor) for control force generation.

In some embodiments, one or more of the propulsion generators 118 includes differential cyclic propeller (e.g., rotor) pitch control. Differential cyclic propeller (e.g., rotor) pitch control is configured to provide at least one additional degree of freedom to the differential collective propeller (e.g., rotor) pitch control. Differential cyclic propeller (e.g., rotor) pitch control is configured to provide finer and faster maneuvering responses.

The navigable craft 100 further includes one or more stabilizers connected to at least one of the non-tiltable propulsion generators, the airfoil, and the fuselage. For example, in some embodiments, the one or more stabilizers include a fuselage stabilizer 108 (e.g., canard) or a rudder 110 that is connected near the nose of fuselage 102. In some embodiments, the one or more stabilizers include rotatable airfoil 106 that is connected to the propulsion generator 118. In some embodiments, the one or more stabilizers are rotatable about an axis of the second cross-sectional end of the airfoil 104. It is contemplated that the one or more stabilizers are configured to be deformed in order to change a cross-section from an end of a respective stabilizer to an opposite end of the respective stabilizer. In some embodiments, the one or more stabilizers include wingtips 112 of the rotatable airfoil 106. In some embodiments, the one or more stabilizers include ailerons and/or flaps that are connected to the airfoil 104.

As depicted in FIG. 1, the navigable craft 100 further includes a landing assembly 116 that is connected to the propulsion generator 118. In some embodiments, the landing assembly 116 is connected to the airfoil 104. It is contemplated that the landing assembly 116 are aligned aerodynamically with the second cross-sectional end of the airfoil 104 and extends in a direction adjacent to the tiltable section of the fuselage 102. In some embodiments, the landing assembly 116 corresponds to a telescoping strut, as depicted in FIG. 1. In some embodiments, the telescoping strut is retractable in that the telescoping strut is configured to be retracted within a portion of the navigable craft 100 (e.g., stowed with the propulsion generator 118, the airfoil 104, fuselage 102, etc.). In some embodiments, the telescoping strut corresponds to one or both of an adjustable spring or an adjustable dashpot. In some embodiments, the telescoping strut corresponds to mechanical adjustors (e.g., screw). In some embodiments, the telescoping strut corresponds to an adjustable hydraulic cylinder or pneumatic cylinder.

In some embodiments, the landing assembly 116 includes a rolling member connected to an end of the telescoping strut. The rolling member is configured to pivot around an axis of the telescoping strut to automatically align the rolling member in a direction of travel. In some embodiments, the rolling member corresponds to a caster wheel.

As depicted in FIG. 1, each landing assembly 116 is displaced to conform to the terrain sloped at a gradient Θ. In some embodiments, the compartment 114 to the tiltable section of the fuselage 102 is realigned to the gradient of the terrain instead of aligned based on the gravity field. This often facilitates offloading equipment from the compartment 114 to the terrain. In some embodiments, each landing assembly 116 is displaced to position the navigable craft 100 based on direction of gravity field rather than aligned with the gradient of the terrain. Aligning the positioning of the navigable craft 100 based on direction of gravity positions the center of mass of the navigable craft 100 equally distributed between each landing assembly 116, which reduces the chance of the navigable craft 100 tipping over.

It should be appreciated that the navigable craft 100 can have two or more wings. For example, navigable craft 100 is exemplified with a set of wings corresponding to four distinct wings as depicted in FIG. 1-FIG. 9. In other embodiments, the navigable craft 100 has two or more distinct wings. For example, the navigable craft 100 can have three distinct wings, four distinct wings, five distinct wings, six distinct wings, etc. It should be appreciated that having more than two wings ensures redundancy in both wings and propulsion generators 118. For example, if one wing and/or one pulsion generator 118 were removed the navigable craft 100 is still maneuverable and can safely pilot and land.

In some embodiments, the distinct wings are evenly distributed around the fuselage 102. In some embodiments, the distinct wings are not evenly distributed around the fuselage 102. In some embodiments, the navigable craft 100 includes at least two of the wings of the set of wings positioned around the non-tiltable section of the fuselage at 180 degrees From each other. In some embodiments, the navigable craft 100 includes at least two of the wings of the set of wings positioned around the non-tiltable section of the fuselage 102 at 45 degrees From each other. In some embodiments, the navigable craft 100 includes at least two of the wings of the set of wings positioned around the non-tiltable section of the fuselage 102 at less than 45 degrees From each other. It should be appreciated that the pulsion generators 118 are evenly distributed around the fuselage 102.

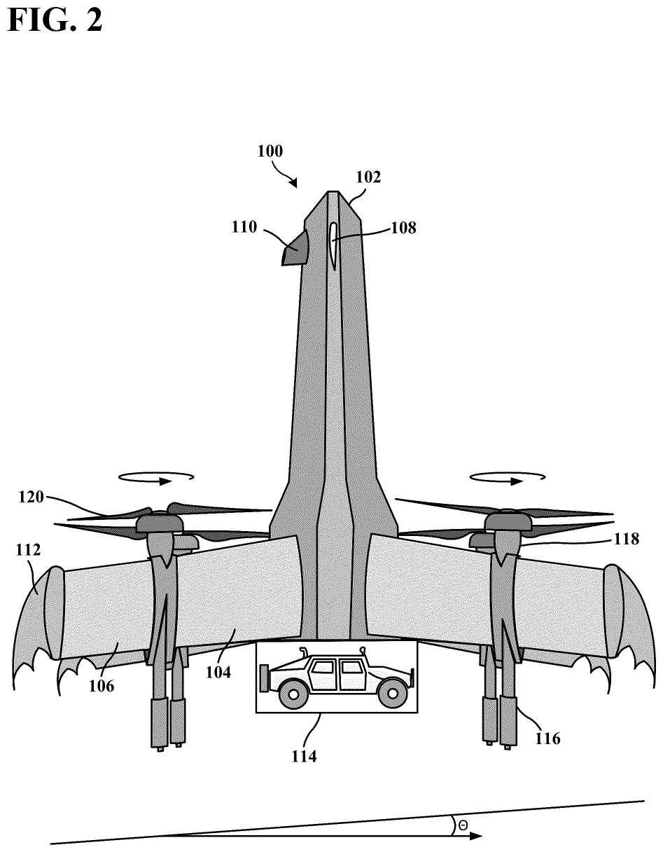

FIG. 2 illustrates the navigable craft 100 in vertical flight mode after take-off from the sloped terrain or prior to landing on the sloped terrain. The take-off and landing are vertically aligned with the gravity field to position the center of mass of the navigable craft 100 equally between each landing assembly 116. It should be appreciated that the navigable craft 100 can hover vertically over the terrain similar to a helicopter. It is contemplated that the navigable craft 100 can hover nose-up where the nose is oriented away from the terrain similar to the orientation illustrated in FIG. 2. It is also contemplated that the navigable craft 100 can hover nose-down where the nose is oriented towards the terrain (not depicted).

In some embodiments, the navigable craft 100 includes an imaging system such as LIDAR or SONAR in order to map the terrain. The imaging system adjusts the position of each landing assembly 116 prior to landing to ensure that the position of the navigable craft 100 based on direction of gravity field rather than aligned with the gradient of the terrain when the navigable craft 100 touches down on the terrain. As depicted in FIG. 2, prior to landing or after take-off the landing assembly 116 is repositioned to the flight positions where the displacement of each landing assembly 116 is reset.

In some embodiments, navigable craft 100 includes a pilot controller. The pilot controller, when aimed at a terrestrial location in the terrain, provides location data that is forwarded to maneuvering controls (e.g., landing controls). In some embodiments, the maneuvering controls (e.g., landing controls) are configured to maneuver the navigable craft 100 to a safe location near the terrestrial location within a risk tolerance. It should be appreciated that the pilot controller can be decoupled from navigable craft 100. For example, the pilot controller can be a mobile or immobile device at a first terrestrial location that targets a second terrestrial location. The pilot controller can be an immobile device affixed to the outside of the navigable craft 100 that targets a terrestrial location from the navigable craft 100. The pilot controller can be a mobile device within the navigable craft 100 that targets a terrestrial location. The pilot controller can be a device affixed to a satellite that targets a terrestrial location. In some embodiments, pilot controller includes a first-person view (FPV) display. In some embodiments, pilot controller includes a virtual reality (VR) simulated first person view from the perspective of the navigable craft 100 or a satellite's perspective. In some embodiments, the location data forwarded to the maneuvering controls (e.g., landing controls) includes a range of the navigable craft 100 from the terrestrial location and a direction to the terrestrial location from the perspective of the navigable craft 100. In some embodiments, pilot controller is a beam rider guide. In some embodiments, the pilot controller resembles a laser pointer.

In some embodiments, the pilot controller is configured to provide multiple terrestrial locations (e.g., waypoints). In such embodiments, the pilot controller forwards a list of the terrestrial locations (e.g., waypoints) to the maneuvering controls (e.g., landing controls). Using the lists of terrestrial locations (e.g., waypoints), the maneuvering controls (e.g., landing controls) is configured to execute movement of the navigable craft 100 to terrestrial locations (e.g., waypoints). In some embodiments, the maneuvering controls (e.g., landing controls) forwards one or more terrestrial locations (e.g., waypoints) to a second navigable craft or device. In some embodiments, the pilot controller includes a sensor system for simplex and/or duplex electromagnetic (e.g., laser, radio) based communication of terrestrial locations (e.g., waypoints) to transmit the one or more terrestrial locations (e.g., waypoints) to the second navigable craft or device.

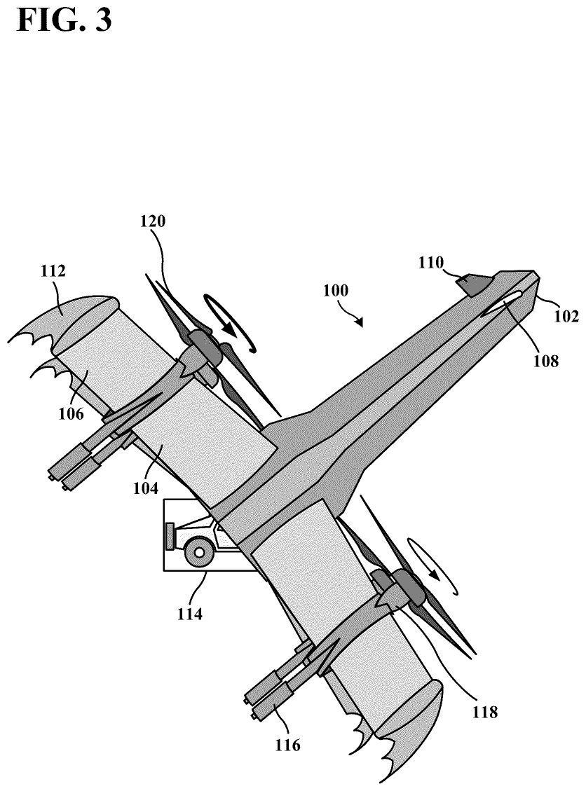

FIG. 3 illustrates the navigable craft 100 when transitioning between vertical flight mode and horizontal flight mode. Increasing the rotational velocity of one or more of the propulsion generators 118, as depicted in the thicker rotational arrow in FIG. 3, causes a rotational maneuver that transitions the navigable craft 100 from vertical to horizontal. Likewise, decreasing the rotational velocity of one or more of the propulsion generators 118, as depicted in the thinner rotational arrow in FIG. 3, causes a similar rotational maneuver that transitions the navigable craft 100 from vertical to horizontal. In some embodiments, the transitions of the navigable craft 100 from vertical to horizontal is facilitated by both increasing the rotational velocity of one or more of the propulsion generators 118 while decreasing the rotational velocity of the remaining one or more of the propulsion generators 118. In some embodiments, the fuselage stabilizer 108 (e.g., canard) or a rudder 110 is manipulated to cause a rotational maneuver that transitions the navigable craft 100 from vertical to horizontal. For example, the fuselage stabilizer 108 (e.g., canard) depicted in FIG. 3 has been rotated to offset the position of the nose of the navigable craft 100 with respect to vertical flight mode or horizontal flight mode (e.g., forward motion through the fluid). In some embodiments, the one or more stabilizers (e.g., fuselage stabilizers 108, canard, etc.) are located near an end (e.g., nose) of the non-tiltable section of the fuselage 102 that act as a “fin” to aerodynamically position the fuselage 102. In some embodiments, the one or more stabilizers (e.g., fuselage stabilizers 108, canard, etc.) include attitude stabilizers (e.g., gas thrustor, compressed air, rocket, plasma, etc.) located near an end (e.g., nose) of the non-tiltable section of the fuselage 102 or wing.

It should be appreciated that transitioning between vertical flight mode and horizontal flight mode provides additional redundancy. For example, if all the pulsion generators 118 cease to function the navigable craft 100 is still maneuverable by transitioning to horizontal flight mode to utilize the lift from the wings similar to a glider. Likewise, if the wings cease to provide lift while in horizontal flight mode, the navigable craft 100 is still maneuverable by transitioning to vertical flight mode similar to a helicopter.

When transitioning between vertical flight mode and horizontal flight mode the adjustable mechanism adjusts the position of the tiltable section so that an attached floor of the compartment 114 remains oriented to the ground while the craft is moving as illustrated in FIG. 3. In some embodiments, the floor of the compartment 114 is adjusted by the adjustable mechanism to position the tiltable section so that an attached floor of compartment 114 differs from the gravity field while the craft is moving. For example, the floor can be tilted toward the direction of forward motion so as not to displace people standing in the compartment 114 (e.g., “remove the rug out from under the people”).

In some embodiments, the tiltable section and/or the adjustable mechanism resembles a dimpled sphere (e.g., joystick) configured to provide six degrees of freedom when orienting the tiltable section with respect to the navigable craft 100 or the ground. In some embodiments, the dimpled sphere (e.g., joystick) includes one or more spheres first with six degrees of freedom. For example, the dimpled sphere (e.g., joystick) can include a first sphere concentric with a second sphere to provide for the airframe's orientation. In some instances, a third sphere is concentric with the first sphere and the second sphere to provide the orientation of the flight direction with respect to a fixture (e.g., pilot chair, co-pilot chair, cargo platform, etc.). In some embodiments, the navigable craft 100 includes more than one tiltable section. For example, the compartment 114 with cargo or personnel can tilt independently from a cockpit that is located at a different portion of the fuselage 102.

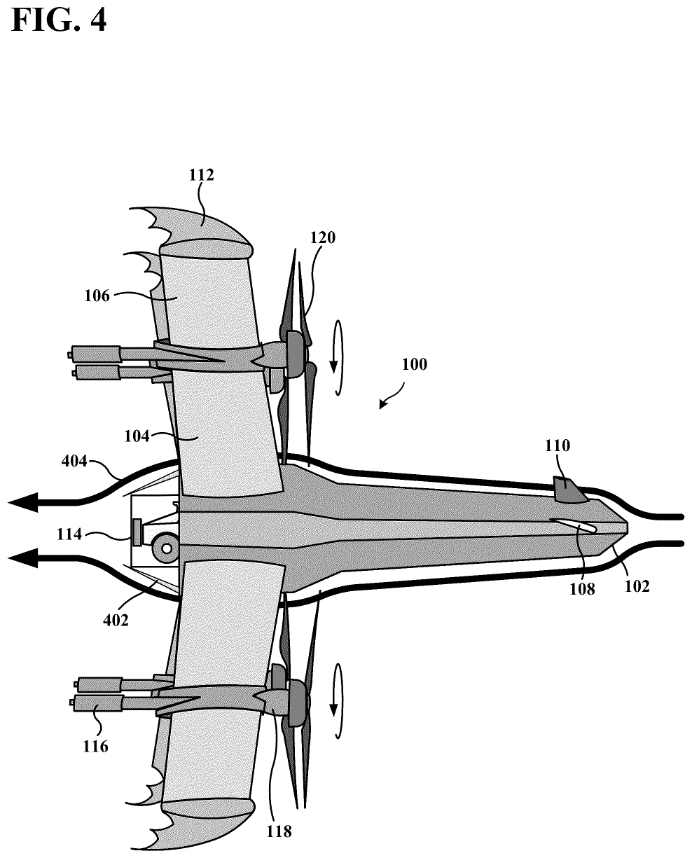

FIG. 4 illustrates the navigable craft 100 when moving through the fluid in horizontal flight mode. In some embodiments, the navigable craft 100 include a shaping hull 402 or skin configured to extend around at least a portion of the compartment 114. In some embodiments, the shaping hull 402 corresponds to a retractable part of the tiltable section of the fuselage. In some embodiments, the shaping hull 402 corresponds to a retractable part of the detachable compartment. In some embodiments, the position of the shaping hull 402 is configured to adjust based on the environment or flight mode. For example, the shaping hull 402 can be retracted during take-off and landing, as depicted in FIG. 1 or extended in order to enhance aerodynamics of the streamline 404 as depicted in FIG. 4. In some embodiments, the position of the shaping hull 402 provides a hermetical seal with respect to the external fluid environment.

In some embodiments, the navigable craft 100 includes a retractable set of landing structures different from the landing assembly 116 of each wing assembly. The retractable set of landing structures includes a landing structure that retracts from the fuselage and two or more landing structures retractable from two or more wings. When the retractable set of landing structures are deployed the navigable craft 100 is capable of landing the navigable craft 100 while in horizontal flight mode. In some embodiments, the retractable set of landing structures includes a rolling member connected to an end of a telescoping strut.

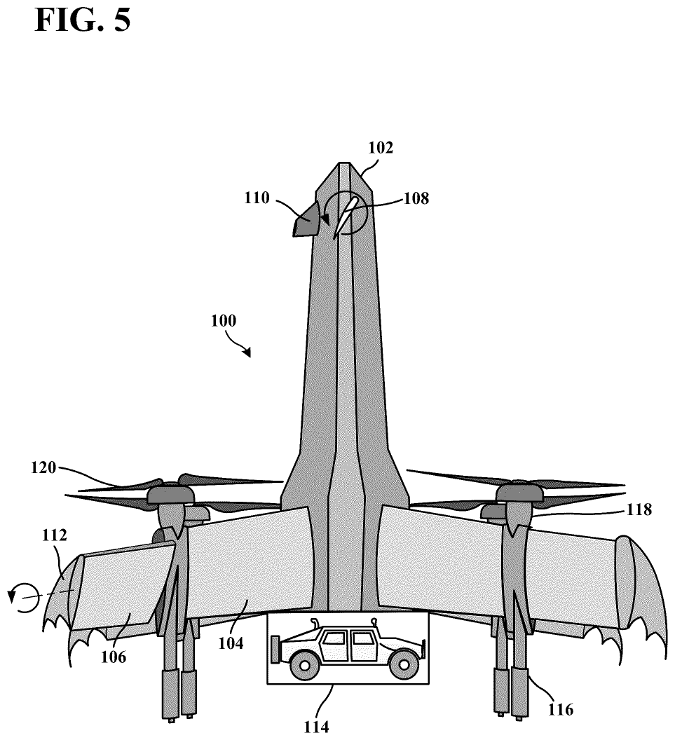

FIG. 5 illustrates the rotational capabilities of the fuselage stabilizer 108 (e.g., canard) and the rotatable airfoil 106 for the navigable craft 100. The frictional forces in combination with center of mass of the navigable craft 100 while in horizontal flight mode can cause a skew of the navigable craft 100 with respect to forward motion. To compensate for this skew, the fuselage stabilizer 108 (e.g., canard) are adjusted to provide a streamline 404 of the navigable craft 100 while in horizontal flight mode. For example, the fuselage stabilizers 108 (e.g., canard) can rotate about a cross-sectional axis, as depicted in FIG. 5. In some embodiments, the fuselage stabilizers 108 (e.g., canard) are deformable where the cross-section of the fuselage stabilizers 108 (e.g., canard) changes from one end to an opposite end. In some embodiments, one or more of the rotatable airfoils 106 are adjusted to compensate for the skew of the navigable craft 100 while in horizontal flight mode. For example, the rotatable airfoils 106 can rotate about a cross-sectional axis, as depicted in FIG. 5. In some embodiments, the rotatable airfoils 106 are deformable where the cross-section of the rotatable airfoils 106 changes from one end to an opposite end. In some embodiments, increasing the rotational velocity of one or more of the propulsion generators 118 compensates for the skew of the navigable craft 100 while in horizontal flight mode. In some embodiments, decreasing the rotational velocity of one or more of the propulsion generators 118 compensates for the skew of the navigable craft 100 while in horizontal flight mode. In some embodiments, increasing the rotational velocity of one or more of the propulsion generators 118 while decreasing one or more of the remaining propulsion generators 118 compensates for the skew of the navigable craft 100 while in horizontal flight mode.

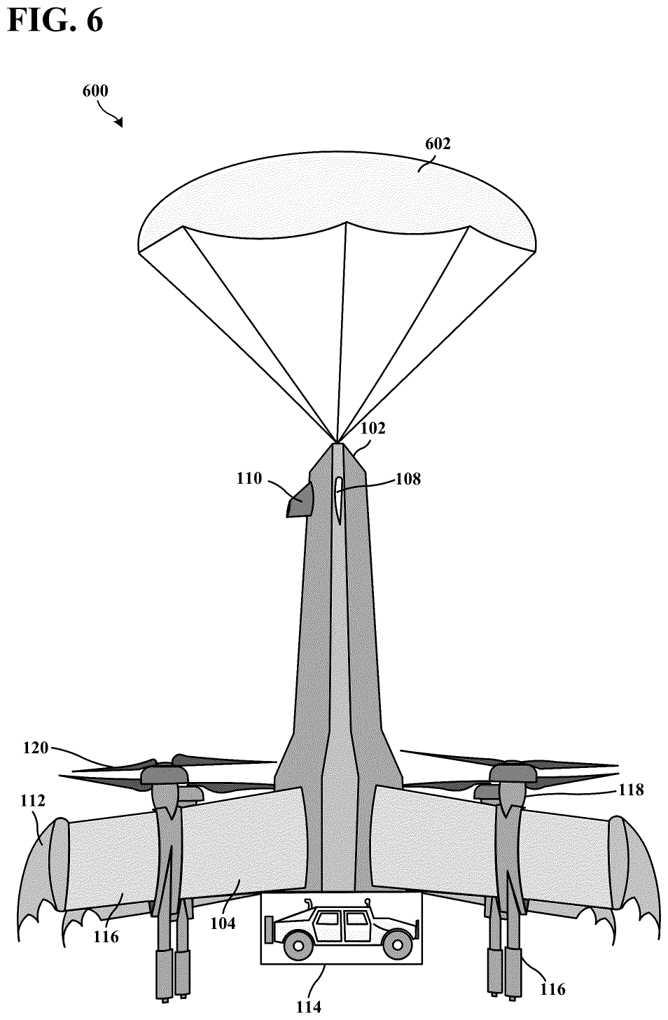

FIG. 6 illustrates a deployed parachute affixed to the navigable craft 100 that is utilized for emergencies. In some examples, the parachute 602 is configured to be deployed from the non-tiltable section of the fuselage 102. The deployable parachute can be stowed and deployed at the nose of the fuselage away from the propulsion generators 118. In some examples, the size cable length of the parachute 602 is configured to not extend to the propulsion generators 118 so as to avoid entangling the parachute 602 in any part of the propulsion generators 118.

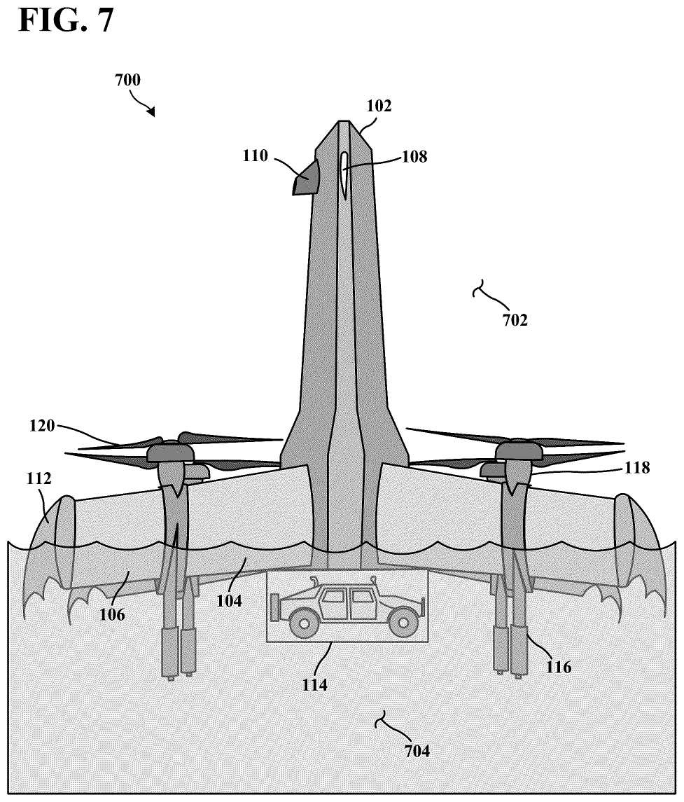

FIG. 7 illustrates the navigable craft 100 oriented in vertical flight mode before take-off or after landing on water 704. In vertical flight mode the center of mass of the navigable craft 100 is equally distributed between each landing assembly 116. As such, the buoyancy of the navigable craft 100 submerges a portion of the navigable craft 100 below the water 704 while the propulsion generators 118 remain above the water 704. In some embodiments, the navigable craft 100 includes one or more ballast tanks configured to be filled with an ambient fluid (e.g., water 704) or a fluid from one or more compressed fluidic tanks (e.g., compressed air). Filling one or more of the ballast tanks with water 704 or air 702 orients the navigable craft 100 with respect to the surface of the water 704 and stabilizes the navigable craft 100.

Disproportionally filling one or more of the ballast tanks on one side the navigable craft 100 changes the center of mass and maneuvers the navigable craft 100 to transition from vertical flight mode to horizontal flight mode. In some embodiments, the ballast tanks are distributed in at least one of the airfoils 104, rotatable airfoil 106, and the fuselage 102. In some embodiments, propulsion generators 118 are hermetically sealed and configured to function both in air 702 and under water 704.

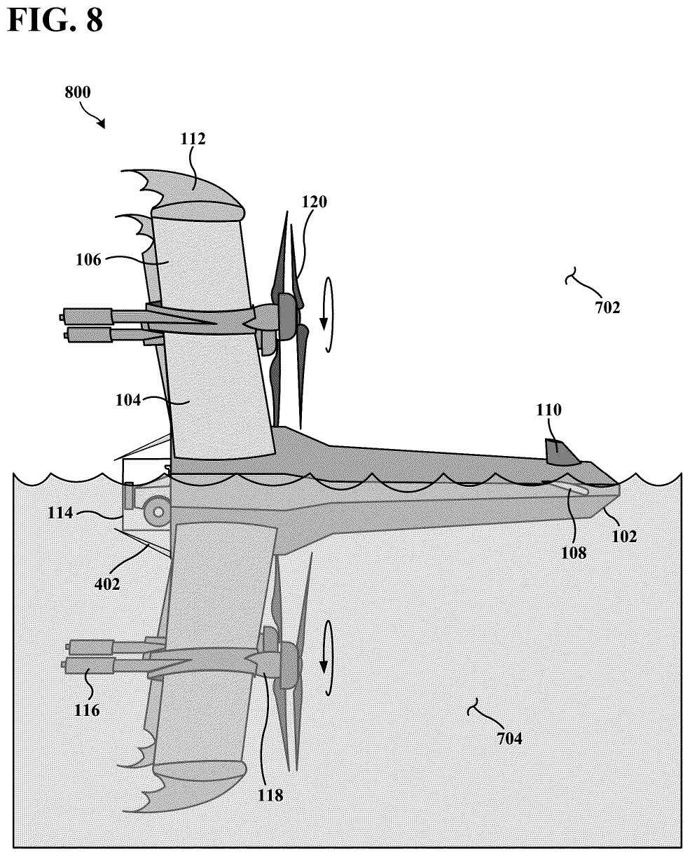

FIG. 8 illustrates the navigable craft 100 oriented in horizontal flight mode on water 704. In some embodiments, the navigable craft 100 maneuvers on top of the water where the propulsion generators 118 that are below the water 704 propel the navigable craft 100 forward while the rotatable airfoil 106 or the one or more stabilizers (e.g., wingtips 112, fuselage stabilizers 108, canard, etc.) adjusts the direction of the air 702 for steering. In some embodiments, the navigable craft 100 maneuvers on top of the water 704 similar to an air boat where the propulsion generators 118 that are above the water 704 propel the navigable craft 100 forward while the rotatable airfoil 106 or the one or more stabilizers (e.g., wingtips 112, fuselage stabilizers 108, canard, etc.) adjusts the direction of the air 702 for steering. In some embodiments, the rotatable airfoil 106 or the one or more stabilizers (e.g., wingtips 112, fuselage stabilizers 108, canard, etc.) that are submerged below the water 704 adjusts steering direction (e.g., a boat rudder).

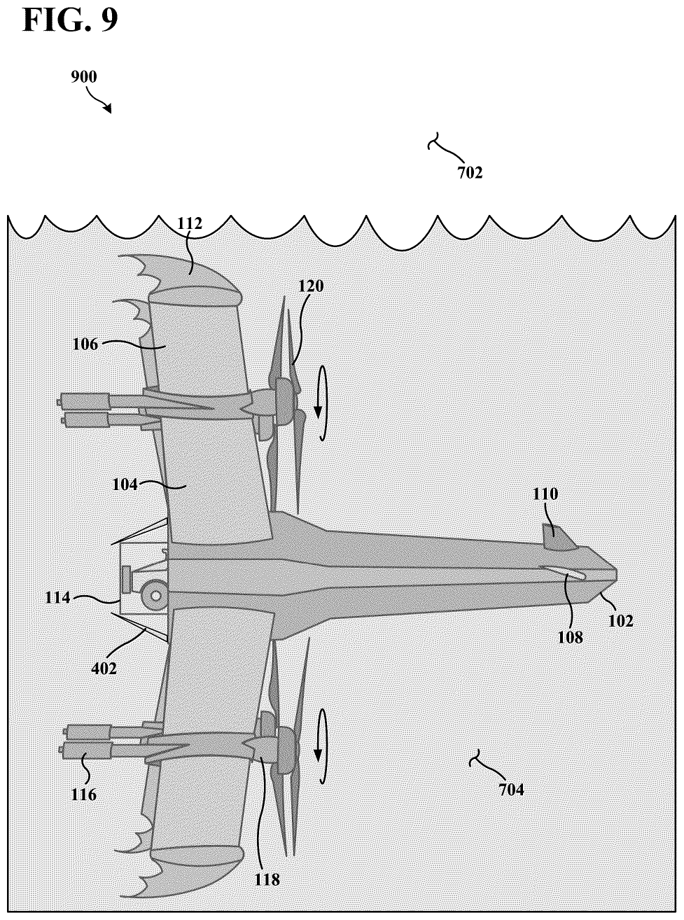

FIG. 9 illustrates the navigable craft 100 oriented in horizontal flight mode below the water 704. In some embodiments, the navigable craft 100 in its entirety is hermetically sealed and configured to be submerged under water 704. As such, adjusting the buoyancy of the navigable craft 100 by filling the one or more of the ballast tanks with water 704 can fully submerge the navigable craft 100 under water 704. Horizontal flight mode under water 704 is similar to horizontal flight mode in air depicted in FIG. 4.

In some embodiments, the fuselage stabilizers 108 (e.g., canard) are adjusted to provide a streamline of the navigable craft 100. The fuselage stabilizers 108 (e.g., canard) are also hermetically sealed and can rotate about a cross-sectional axis without water 704 entering the navigable craft 100. In some embodiments, the fuselage stabilizers 108 (e.g., canard) are deformable where the cross-section of the fuselage stabilizers 108 (e.g., canard) changes from one end to an opposite end without breaking the hermetic seal. In some embodiments, one or more of the rotatable airfoils 106 are adjusted to provide a streamline of the navigable craft 100. The rotatable airfoils 106 are hermetically sealed and can rotate about a cross-sectional axis without water 704 entering the navigable craft 100. In some embodiments, the rotatable airfoils 106 are deformable where the cross-section of the rotatable airfoils 106 changes from one end to an opposite end without breaking the hermetic seal. In some embodiments, increasing the rotational velocity of one or more of the propulsion generators 118 can provide a streamline of the navigable craft 100. In some embodiments, decreasing the rotational velocity of one or more of the propulsion generators 118 can provide a streamline of the navigable craft 100. In some embodiments, increasing the rotational velocity of one or more of the propulsion generators 118 while decreasing one or more of the remaining propulsion generators 118 can provide a streamline of the navigable craft 100.

It is contemplated that the air 702 and the water 704 can be other fluids. For example, the navigable craft 100 can be fully submerged in saltwater at a halocline or in freshwater at a thermocline.

The previous description is provided to enable any person skilled in the art to practice the various examples described herein. Various modifications to these examples will be readily apparent to those skilled in the art, and the generic principles defined herein may be applied to other examples. Thus, the claims are not intended to be limited to the examples shown herein, but are to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other examples. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B. or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various examples described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed under 35 U.S.C § 112(f) unless the element is expressly recited using the phrase “means for.”

1. A navigable craft, comprising:
a fuselage with a tiltable section positioned behind a non-tiltable section opposite to a nose of the navigable craft;
a set of wings connected to the non-tiltable section of the fuselage, wherein each wing of the set of wings includes:
an airfoil connected to the non-tiltable section of the fuselage at a first cross-sectional end of the airfoil; and
a non-tiltable propulsion generator connected to a second cross-sectional end of the airfoil opposite to the first cross-sectional end of the airfoil, wherein the non-tiltable propulsion generator extends parallel and adjacent to the non-tiltable section of the fuselage;
one or more stabilizers connected to at least one of the non-tiltable propulsion generator, the airfoil, and the fuselage; and
a landing assembly connected to the non-tiltable propulsion generator or the airfoil, wherein the landing assembly is aligned aerodynamically with the second cross-sectional end of the airfoil and extends in a direction adjacent to the tiltable section of the fuselage.

2. The navigable craft of claim 1, wherein the tiltable section of the fuselage is configured to tilt based on a direction of gravity.

3. The navigable craft of claim 1, wherein the landing assembly corresponds to a telescoping strut.

4. The navigable craft of claim 3, wherein the landing assembly further includes a rolling member connected to an end of the telescoping strut, wherein the rolling member is configured to pivot around an axis of the telescoping strut to automatically align the rolling member in a direction of travel.

5. The navigable craft of claim 1, further comprising:
a retractable set of landing structures different from the landing assembly connected to the non-tiltable propulsion generator or the airfoil, wherein the retractable set of landing structures includes a landing structure retractable from the fuselage and two or more landing structures retractable from two or more wings.

6. The navigable craft of claim 1, wherein the one or more stabilizers are rotatable about an axis of the second cross-sectional end of the airfoil or the one or more stabilizers are deformable.

7. The navigable craft of claim 1, wherein the one or more stabilizers are located substantially at an end of the non-tiltable section of the fuselage.

8. The navigable craft of claim 1, further comprising:
a detachable compartment connected to the tiltable section of the fuselage.

9. The navigable craft of claim 8, further comprising:
a shaping hull configured to extend around at least a portion of the detachable compartment.

10. The navigable craft of claim 9, wherein the shaping hull is configured to be retracted within the fuselage.

11. The navigable craft of claim 1, wherein the non-tiltable propulsion generator corresponds to a motor with a propeller.

12. The navigable craft of claim 1, wherein the propulsion generator is hermetically sealed.

13. The navigable craft of claim 1, further comprising:
one or more ballast tanks configured to be filled with an ambient fluid or a fluid from one or more compressed fluidic tanks.

14. The navigable craft of claim 1, further comprising:
a deployable parachute configured to be deployed from the non-tiltable section of the fuselage.

15. The navigable craft of claim 1, wherein the set of wings correspond to four distinct wings.

16. The navigable craft of claim 15, wherein at least two wings of the set of wings are positioned around the non-tiltable section of the fuselage at 180 degrees From each other.

17. The navigable craft of claim 16, wherein at least two wings of the set of wings are positioned around the non-tiltable section of the fuselage at 45 degrees From each other.

18. The navigable craft of claim 16, wherein at least two wings of the set of wings are positioned around the non-tiltable section of the fuselage at less than 45 degrees From each other.

19. A navigable craft, comprising:
a fuselage;
a compartment operatively coupled to the fuselage, wherein the compartment is configured to maintain orientation independent of orientation of the fuselage;
a set of wings connected to the fuselage, wherein each wing of the set of wings includes:
an airfoil connected to the fuselage at a first cross-sectional end of the airfoil; and
a propulsion generator connected to a second cross-sectional end of the airfoil opposite to the first cross-sectional end of the airfoil, wherein the propulsion generator extends parallel and adjacent to the fuselage;
one or more navigational stabilizers connected to at least one of the propulsion generator, the airfoil, and the fuselage; and
a landing assembly connected to the set of wings, wherein the landing assembly is aligned aerodynamically with the second cross-sectional end of the airfoil and extends parallel and adjacent to the fuselage.

20. (canceled)

21. A navigable craft, comprising:
a fuselage with a tiltable section positioned behind a non-tiltable section opposite to a nose of the navigable craft;
a set of wings connected to the non-tiltable section of the fuselage, wherein each wing of the set of wings includes:
an airfoil connected to the non-tiltable section of the fuselage at a first cross-sectional end of the airfoil; and
a propulsion generator connected to a second cross-sectional end of the airfoil opposite the first cross-sectional end of the airfoil, wherein the propulsion generator extends parallel and adjacent to the non-tiltable section of the fuselage;
one or more stabilizers connected to at least one of the propulsion generator, the airfoil, and the fuselage;
a landing assembly connected to the propulsion generator or the airfoil, wherein the landing assembly is aligned aerodynamically with the second cross-sectional end of the airfoil and extends in a direction adjacent to the tiltable section of the fuselage; and
an adjustable mechanism configured to adjust a tilt angle of the tiltable section of the fuselage in response to flight conditions.
